(19) United States
(12) Patent Application Publication
(10) Pub. No.: US 2026/0309429 A1
(43) Pub. Date: Oct. 8, 2026

(54) FALLING FILM EVAPORATOR

(71) Applicant: BITZER Kühlmaschinenbau GmbH, Sindelfingen (DE)

(72) Inventors: Simone GIRARDI, Colleferro (IT); Federico FIORESE, Isola Vicentina (IT)

(21) Appl. No.: 19/478,074

(22) PCT Filed: Apr. 27, 2023
(86) PCT No.: PCT/EP2023/061172

§ 371 Date: Oct. 23, 2025

(51) Int. Cl. F28D 7/16; B01D 1/04; F25B 39/02; F28D 3/02; F28D 3/04; F28D 5/02; F28D 21/00; F28F 25/06

(52) U.S. Cl. CPC F28D 7/1607; B01D 1/04; F25B 39/028; F28D 3/02; F28D 3/04; F28D 5/02; F28F 25/06; F28D 2021/0071

(57) ABSTRACT

A heat exchanger includes a shell and at least one bundle of heat exchanger tubes arranged within the shell. The heat exchanger tubes have a tube length defining a horizontal x-direction and a vertical extension defining a z-direction that is orthogonal to the x-direction. At least one refrigerant distribution layer is located above at least one bundle of heat exchanger tubes. The at least one refrigerant distribution layer includes perforated pipes having holes for emitting refrigerant towards the bundle of heat exchanger tubes above which the refrigerant distribution layer is located. At least some of said perforated pipes have a longitudinal axis defining a horizontal y-direction that is orthogonal to the x-direction defined by the heat exchanger tubes. Perforations of the perforated pipes have a longitudinal y-direction that is orthogonal to the x-direction defined by the heat exchanger tubes and are formed by holes that are arranged in sets.

Conventional vapor compression refrigerant systems, used for air-conditioning or refrigeration application, include an evaporator which is the heat exchanger where the transfer of thermal energy takes place between the process fluid, which must be cooled, and the refrigerant fluid of the system. Different types of evaporators have been designed. There are three typologies that are characterized by the highest performance: Flooded Evaporators, Pure Falling Film Evaporators, Hybrid Falling Film Evaporators type. Of these types, those that have achieved the greatest success in the field of air conditioning and refrigeration application, are the first and the last.

All the three typologies are characterized by having a plurality of horizontal tubes within a shell. The process fluid which needs to be cooled passes inside the tubes and transfers heat to the refrigerant fluid which flows on the shell side of the heat exchanger, in contact with the external surface of the tubes.

Since these types of evaporators all belong to a same subgroup of the shell and tube heat exchanger family, the passage of the process fluid inside the tubes can take place through different configurations, called single pass (1P) or multiple pass (2P two-pass, 3P three pass, 4P, . . . ), the choice of the design to use is made according to the available temperature difference and the volumetric flow rate of the fluid in such a way as to work with an optimal velocity inside the tubes for heat exchange performance without exceeding the limit value of allowed pressure drop, the latter proportional to the pumping power required to move the process fluid.

In the 1-pass configuration the process fluid enters the tubes on one side and exits on the opposite side.

In a 2-pass configuration, the process fluid enters only a fraction of the total tubes on one side, exits from the opposite side thus performing the first passage, and then re-enters the remaining total tubes fraction by traveling in the opposite sense to what was done in the first pass.

In configurations with a greater number of passages, the fluid alternates passages in opposite sense crossing a number of portions of the total tube bundle equal to the number of passages.

In the Flooded Evaporator type the tubes are positioned inside the shell in correspondence with approximately the lower half of the shell. During the operation the refrigerant, in the form of liquid or liquid-vapour mixture, enters the heat exchanger through an inlet connection generally positioned at the bottom of the shell and floods the portion of the shell containing the tubes, the half lower part, thus wetting the external surface of the tubes and thus reaching the high expected performance. It is clear that one of the weaknesses of this design is the high refrigerant charge required to perform a complete wetting of the tube bundle.

The Pure Falling Film Evaporator type differs from the Flooded one in that the refrigerant, in the form of liquid or liquid-vapour mixture, is distributed on the external surface of the tubes through a distribution system generally positioned above the tube bundle. The liquid portion of the refrigerant distributed on the upper tube rows of the tube bundle will begin to vaporize partially, the remaining part will fall on the rows of tubes below, forming a liquid film on the latter, a liquid film which will thin as it descends to the bottom with the rows of tubes due to the vaporization process that contin-ues in the meantime.

Since it is very complicated to carry out an optimal distribution of the refrigerant on the external surface of the tubes of the tube bundle, to continue to obtain good heat transfer performances similar to those of the Flooded type, it is necessary to work with a feeding of the refrigerant such that a portion of it is in excess after the vaporization process and must be removed from the lower part of the shell, below the tube bundle, where it starts to collect, since in the Pure Falling Film Evaporator one does not want the refrigerant to flood any portion of the tube bundle. Normally this excess liquid refrigerant is recirculated through liquid recirculation systems that complicate the configuration of the system.

The Hybrid Falling Film Evaporator type is substantially similar to the Pure one with the difference that instead of recir-culating the excess liquid, this is left to accumulate on the bottom part of the shell until it floods a certain portion of the tube bundle, a portion which actually operates as a flooded evaporator: hence the hybrid denomination.

With the Hybrid configuration the benefit of the Pure Falling Film type of having a reduced refrigerant charge is kept al-most intact compared to a solution with Flooded Evaporator, and at the same time the configuration is simplified by elimi-nating the liquid recirculation systems.

All the three typologies can be easily implemented in a multi-circuit configuration that can be used in very common applications requiring high cooling capacities, in which it is necessary to use more than one compressor each belonging to an independent cooling circuit: this configuration is often required also for redundancy reason.

In this multi-circuit evaporator configuration the process fluid to be cooled comes into contact with different portion of heat exchange surface, each portion in contact with the refrigerant fluid belonging to a different refrigerant circuit. This configuration is achieved by using intermediate tube-sheets to separate the various circuits on the refrigerant side: in each single passage of the process fluid inside any tube, the process fluid will exchange heat with the various circuits.

In general, one of the key objectives of a heat exchanger is a maximization of the heat transfer performance of a heat exchanger surface.

In the case of heat exchangers of falling film evaporator type with horizontal tubes, independent of whether it is of hybrid or pure type, whether it is used for air-conditioning or refrigeration application, or whether the fluid to be distributed is a refrigerant in the liquid physical state or in a two-phase vapor-liquid physical state, the optimal distribution of the refrigerant on the external surface of the tubes, both in terms of mass flow rate and vapor quality for unit length of each specific tube (which in turn is dependent on the required cooling capacity as a consequence of the specific conditions, temperature and flow rate of the heat transfer fluid/process fluid flowing inside the tubes themselves), and the consequent optimal geometric configuration of the liquid refrigerant film to be vaporized around the tubes, are some of the main objectives to be achieved in order to maxim-ize the heat transfer performance of the heat exchanger surface. This optimal distribution of the refrigerant on the external surface of the tubes is strongly penalized by several factors, specifically:
the need to have a compact configuration of the tube bundle and shell assembly for cost reasons;
the need to reduce the number and the complexity of components required, again for cost reasons;
the vaporization of the refrigerant along the distribution lines due to pressure drops (this means that the refrigerant fluid can be distributed in different points with a different vapor quality);
the interaction that occurs inside the shell but outside the tubes, of the refrigerant (one or two-phase) distributed on the external surface of the tubes with the flow of the vaporized refrigerant produced on the external surface of the same (by the heat exchange with the fluid to be cooled flowing inside the tubes), which interaction leads to the disruption of the liquid falling film with negative consequences on the heat transfer coefficient;
the difficulty for a “static” distribution System to sat-isfy the goal for optimality under very different load conditions, for example both at full load and at minimum load; and/or
the difficulty for a distribution System design to sat-isfy the goal for optimality under very different application conditions, for example evaporators belonging to chillers with medium-high pressure refrigerants (with large difference between condensing pressure and evapo-rating pressure) and low pressure refrigerants.

One of the main causes of not reaching the optimal distribution defined above, common to all known configurations, is that of the inefficient distribution of the refrigerant fluid, leaving the generic distribution system, on the external surface of the horizontal tubes positioned on the upper rows of the tube bundle (the rows of tubes positioned immediately below the distribution system). The efficiency of this first distribution on the upper tube rows is generally penalized by design solutions with a limited number of components requiring a limited space.

The inefficiency of distribution on these upper rows can only be partially recovered in the subsequent drop and distribution of the liquid film on the underlying tube rows, therefore it plays a key role in the design of any distribution system.

In the prior art, two classes of refrigerant distribution systems are known: pure liquid distributors and vapor/liquid mixture distributors.

Refrigerant distribution systems of the pure liquid distributor type require a vapor separation system upstream of the distribution System itself, which leads to a higher complexity. Generally, pure liquid distributor systems are conceived as a set of parallel pipes, connected to each other by means of manifolds (also referred to as collectors), parallel pipes having holes of various geometries (circular, elliptical, rectangular, . . . ) in the lower part, so that the liquid falls substantially through a vertical trajectory (or at a small angle to the vertical direction) directly on the heat exchanger tube.

Usually, the pipes of the distributor are parallel to the heat exchanger tubes, in such a way as to reduce the necessary number of pipes of the distributor and the relative welding to the manifolds.

In order to be efficient, these Systems require a very large number of holes, as in the first upper row of heat exchanger tubes the liquid fed remains localized in correspondence with the vertical passing through the hole, and slowly begins to redistribute itself more along the length of the tube. For this purpose, perforated plates (or sheets) are often used to redistribute the liquid, which in any case constitute an obstruction to the passage of the rising vapor that is being produced. The greatest penalty occurs at partial loads, as the liquid tends to remain even more localized due to a very low flow rate, thus accentuating the creation of dry-spot areas on the heat exchanger tube.

Refrigerant distribution systems of the vapor/liquid mixture distributor type usually do not make use of perforated pipes, but rather use nozzles designed in an optimal way to exploit the high output velocity of the refrigerant in the two-phase state to obtain a spray effect capable of distributing the refrigerant on a large surface.

However, these systems using nozzles have some limitations: First of all, free space is needed between the respective nozzle and the tube bundle in order to make efficient use of the spray effect and thus obtain a good distribution over a large surface. As a consequence, the vertical size of the distribution system including the nozzle and the free space between the nozzle itself and the tube bundle, usually has a non-negligible extension, thus resulting in being not optimal in cases where the overall cost of the evaporator is particularly sensitive to compactness.

Furthermore, a significant variation on the distribution efficiency can occur when the capacity load varies.

Furthermore, in contrast to distribution systems of pure liquid type, distribution systems of vapor/liquid mixture type (regardless of whether they use perforated pipes or nozzles) are subject to phenomena of intermittent and stratified flows inside the manifolds and in the pipes themselves in case of very low refrigerant flow rates. Such intermittent flow phenomena usually generate a maldistribution effect. A way to avoid such problems is that to design carefully the sizes of the various components taking into account the entire operating range.

Another recurring problem in applications with shell and tube falling film evaporators with horizontal tubes, which appears for both pure or hybrid falling film type, is that of the high entrainment of liquid, in the form of droplets and mists, in the outlet flow of refrigerant vapor produced and sent to the compressor. The presence of refrigerant liquid at the compressor inlet can represent a risk for the reliability of the same and can generate malfunctions in the overall management of the chiller.

Examples for falling film evaporators of various types are disclosed e.g. in a) U.S. Pat. No. 6,830,099 B2, b) U.S. Pat. No. 9,759,461 B2, c) U.S. Pat. No. 10,132,537 B1, and d) EP 2 482 007 B1.

All the above evaporator designs present problems, in different grades.

All the configurations from a) to c) have a single layer distribution system: since the tube bundle can have in the major-ity of cases several horizontal rows of tubes, normally more than 4 rows, a single layer distribution system has the problem of high diversity of the thickness of the falling liquid film which, according to experimental evidence, presents a not so wide range of optimality with respect to the resulting heat transfer coefficient. The need to guarantee an adequate thickness to the liquid film (or at least the wettability ofthe surface) in the horizontal row of tubes located in the lowest position with respect to the distribution System, determines that an overfeeding of the first rows of tubes is necessary, the greater the number of rows of tubes to be fed and the less optimal the distribution of the refrigerant on the horizi-zontal top row(s) of tubes is.

All the configurations from a) to c) have the counter-current flow configuration i.e. that the falling liquid travels in the opposite direction to the refrigerant vapor produced in the lower sections of the evaporator: this configuration, if it is not possible to limit the velocity of the ascending vapor by appropriately increasing, in different ways, the free passage section of the same, causes 2 negative effects:
1) is the breaking of the liquid film on the tubes, with negative consequences on the heat transfer coefficient;
2) is the entrainment of droplets of liquid inside the vapor flow which, if not adequately separated and recovered or vaporized with thermal sources, will be to end up in the compressor suction with negative consequences for it and for the chiller.

The configurations shown solve the problem by creating free passage sections for the rising vapour with a consequent re-duction in the number of heat exchange tubes that can be used for a given shell size, with a significant negative impact on product costs for specific cooling capacity. Again, this stresses the importance of the distribution of the refrigerant on the uppermost row(s), which can at least ease these problems.

The configuration d) solves the problem of liquid entrainment using a co-current configuration of vapor and liquid flows: thanks to a hood that surrounds the part of the tube bundle designed for falling film evaporation operation, the vapor produced is forced to flow from top to bottom together with the distributed liquid before it can rise again laterally (between the hood and the shell), after an abrupt change in direction, towards the vapour outlet connection always positioned in the upper part of the shell. Configuration d) also introduces at least one further distribution level that re-duces the problems due to the overfeeding.

With this configuration d) the free passage sections for the ascending vapour can be reduced but not cancelled, therefore there is still a negative impact on the potential maximum filling of the shell with tubes. The overall path for the vapour from the surface where it is produced and the suction outlet is elongated and with changes in directions, so the overall refrigerant pressure drop is increased, with impact on overall performance.

Accordingly the problem to be solved by this invention is providing a heat exchanger of horizontal tube falling film evaporator type that allows for an optimized distribution of refrigerant on the upper row(s) of heat exchanger tubes of a tube bundle.

This problem is solved by a heat exchanger of horizontal tube falling film evaporator type with the features of independent claim 1. Further advantageous features of such a heat exchanger are subject of the dependent claims.

According to the invention, the heat exchanger (1,100) of horizontal tube falling film evaporator type, comprises a shell and at least one bundle of heat exchanger tubes that is arranged within the shell.

It should be stressed that the horizontal tube falling film evaporator according to the invention may be a hybrid type evaporator or a pure type evaporator; the invention is not re-stricted to one of these types.

Said heat exchanger tubes have a tube length Lₜ defining a horizontal x-direction, which implies that the tubes run essentially straight. Also, this tube length defines necessarily a horizontal axis due to the fact that the heat exchanger is of falling film type and thus the orientation of a heat exchanger in space is defined. As a precaution, it is mentioned that due to the fact that the claimed heat exchanger is of falling film type with horizontal tubes there is a well defined orientation of the heat exchanger in space and the directions “up” and “down” for a given heat exchanger are clearly defined for the person skilled in the art by the direction in which refrigerant falls.

It should also be mentioned that the word “bundle” is used to describe a grouping of heat exchanger tubes extending horizontally that has more than one row, where all the tubes belonging to the same row lie on the same horizontal plane (i.e. there is at least one heat exchanger tube that is located at a different vertical position than the other heat exchanger tubes; typically several rows of heat exchanger tubes will form a bundle). The use of the word “bundle” is not to imply that such a group of heat exchanger tubes are held together by some device.

Therefore, said bundle of heat exchanger tubes has a vertical extension H_{tb},H_{tb1},H_{tb2} (i.e. requires a specific amount of space in the vertical direction) which defines a z-direction that is orthogonal to said x-direction. Preferably, the tube length Lₜ is larger than the vertical extension H_{tb}.

The heat exchanger according to the present invention further comprises at least one refrigerant distribution layer located above at least one bundle of heat exchanger tubes, which condition is met as soon as there is one bundle of heat exchanger tubes arranged below said refrigerant distribution layer, so that said refrigerant distribution layer may also be located between two bundles of heat exchanger tubes.

Said at least one refrigerant distribution layer comprises perforated pipes which have holes for emitting refrigerant towards the bundle of heat exchanger tubes above which said refrigerant distribution layer is located. In the context of this invention, emission towards the bundle means that the refrigerant that emerges from these holes (which holes may also be a part, e.g. the entry, of a nozzle; the invention is not limited to pure liquid refrigerant systems) initially moves into a direction which has a vertical component towards the bundle. In other words, emission towards the bundle does not imply that this emission is in the vertical direction/directly towards the bundle.

An important feature of the invention is that at least some of said perforated pipes have a longitudinal axis defining a horizontal y-direction that is orthogonal to the x-direction defined by said heat exchanger tubes. As a consequence of this geometry, the perforated pipes extending in this direction extend over a plurality of heat exchanger tubes that belong to the bundle and can form at least a part of a layer of heat exchanger tubes in said bundle. Conversely, different sections of the same heat exchanger tube in a top layer of the bundle will typically be provided with refrigerant by different perforated pipes arranged in said direction.

A further important feature of the invention is that perforations of the perforated pipes having a longitudinal y-direction that is orthogonal to the x-direction defined by said heat exchanger tubes are formed by holes that are arranged in sets, wherein each set of holes is arranged on a circumference lying on a vertical xz-plane that passes through a heat exchanger tube of the bundle. Furthermore, the holes of a given set of holes are located above a respective heat exchanger tube of said bundle of heat exchanger tubes, so that refrigerant emitted from the holes of a given set of holes propagates towards this heat exchanger tube.

As mentioned already above, the holes may also form a part of a nozzle.

Specifically, it should be noted that in order to realize the claimed features, it is not necessary that the refrigerant distribution layer is arranged inside the shell in its en-tirety. Whereas evidently this is a necessary condition for sections of the perforated pipes in which the sets of holes are present, e.g. a common supply line for the perforated pipes or individual supply lines for the perforated pipes may also be located outside of the shell.

The thickness of the perforated pipes is preferably chosen in such a way that it resists internal pressure between 10 kPa and 600 kPa. Preferred thickness values range from 0.5 mm to 4 mm, depending on the application and the material. Preferred materials are copper, carbon steel and stainless steel.

The proposed configuration is an improvement compared to ones known from the art as it exploits the kinetic energy of the fluid jet exiting the hole and the angle of impact of the jet itself with the external surface of the heat exchanger tube to be fed, to obtain a better distribution of the jet itself along the longitudinal axis of the heat exchanger tube.

It should be noted that this configuration includes the variation of the number, dimensions and/or shape of holes not only between the sets of holes belonging to different perforated pipes, but also of the holes forming a given set of holes on a given perforated pipe and even of the holes that form a single set of holes. This allows the person skilled on the art to op-timize the refrigerant distribution with respect to the optimal velocity for the different refrigerant fluids and for the entire operating range of the evaporator. This benefit is greatest in the conditions of minimum load with reduced quan-tities of fluid distributed.

Preferred diameters of the holes are between 0.3 mm and 1 mm.

Preferably, the number of holes per set is between 5 and 11 in order to help to reduce the number of perforated pipes required to cover the entire length of a heat exchanger tube.

Also preferably, the number of holes per set is odd and the position of the holes of a set is symmetric relative to a central hole that is positioned at the bottom of the perforated pipe that faces directly the heat exchanger tube located below said set of holes (and thus emits refrigerant essentially in the vertical direction).

A more homogenous distribution of refrigerant on the heat exchanger tubes can be obtained if the holes of a given set of holes are arranged in such a way on the circumference of the pipe that the respective distances between a first intersection point that is formed by a respective first straight line passing through a first hole and the center of the perforated pipe with the heat exchanger tube located below said set of holes and a second intersection point that is formed by a respective second line passing through a neighboring second hole and the center of the perforated pipe with the heat exchanger tube located below said set of holes are equal. In this way, assuming a linear propagation of the refrigerant that is emitted from the holes, the refrigerant will hit the heat exchanger tube at equidistant locations.

Preferably in the heat exchanger the condition 1<(A/Dₚₚ)/nₕ<3 is met, wherein A defines the distance between the centers of two adjacent ones of the perforated pipes having a longitudinal axis defining a horizontal y-direction that is orthogonal to the x-direction defined by said heat exchanger tubes, wherein D_{PP} is the diameter of the perforated pipes and nₕ is the number of holes belonging to a set of holes.

A preferred structure of the refrigerant distribution layer is a central refrigerant feed pipe that extends parallel to the heat exchanger tubes and several perforated pipes having a longitudinal axis defining a horizontal y-direction that is orthogonal to the x-direction defined by said heat exchanger tubes, wherein perforations of the perforated pipes are formed by holes that are arranged in sets, wherein each set of holes is arranged on a circumference lying on a vertical xz-plane that passes through a heat exchanger tube of the bundle and located above a respective heat exchanger tube of said bundle of heat exchanger tubes, wherein said perforated pipes are connected directly to the central feed pipe. Typically, this leads to an antenna-like structure.

According to a preferred embodiment of the heat exchanger, which can be relevant especially e.g. in case the process fluid to be cooled is flowing inside the heat exchangers tubes in a single pass configuration, the diameter of holes and/or the number of holes per set of holes in perforated pipes having a longitudinal axis defining a horizontal y-direction that is orthogonal to the x-direction defined by the heat exchanger tubes that are located closer to the high temperature end of the heat exchanger tubes, corresponding to the high temperature region of the process fluid to be cooled flowing inside the heat exchanger tubes, is larger than the diameter of holes and/or the number of holes per set of holes in perforated pipes having a longitudinal axis defining a horizontal y-direction that is orthogonal to the x-direction defined by the heat exchanger tubes that are located further away from the high temperature end of the heat exchanger tubes. As the ex-changeable heat capacity is higher, more refrigerant can be vaporized where ΔT, i e. the temperature difference between falling refrigerant and medium in heat exchange tubes, is larger, thus it is advantageous to distribute a greater refrigerant mass flow rate at the high temperature side than that distributed at the lower temperature side.

Another way that can be alternatively or additionally used to achieve such an effect is that the distance between adjacent perforated pipes having a longitudinal axis defining a horizontal y-direction that is orthogonal to the x-direction defined by the heat exchanger tubes that are located closer to the high temperature end of the heat exchanger tubes is smaller than the distance between adjacent perforated pipes having a longitudinal axis defining a horizontal y-direction that is orthogonal to the x-direction defined by the heat exchanger tubes that are located further away from the high temperature end of the heat exchanger tubes.

Preferably, the heat exchanger comprises several refrigerant distribution layers.

These refrigerant distribution layers may be arranged horizontally next to each other, especially in such a way that at least two refrigerant distribution layers that are arranged horizontally next to each other are arranged above different sections of the same bundle of heat exchanger tubes.

Additionally or alternatively, the heat exchanger may comprise several refrigerant distribution layers that are arranged vertically above each other and distant to each other in the vertical z-direction and several bundles of heat exchanger tubes that are arranged vertically above each other and distant to each other in the vertical z-direction, said several refrigerant distribution layers and said several bundles of heat exchanger tubes being arranged in such a way that each refrigerant distribution layer is arranged above at least one bundle of heat exchanger tubes, thus forming a distribution layer.

Each of the refrigerant distribution layers has the features of the refrigerant distribution layer as defined above, but not necessarily the same with respect to the collector, pipe diameter, hole size, set(s) of holes, number of holes and angles between holes/under which refrigerant is emitted from the holes. Each distribution layer thus defined is arranged inside the shell at different heights (levels), so as to distribute the refrigerant to a specific portion of the tube bundle positioned below the distribution layer itself in the falling film mode. The portion of the refrigerant fluid distributed by each distribution layer will be a consequence of the geometric characteristics of the components designed for each distribution layer.

In this way it will be possible to design each distribution layer in such a way that the quantity of refrigerant distributed by each of them is possibly equal to that expected to be vaporized by the portion of the tube bundle below it, depending on the type of tube and the conditions (tube inlet temperature and fluid velocity) of each passage of the fluid inside the tubes of this specific portion.

As an example to clarify what has been said, in a shell and tube configuration having a double water passage on the tube side, with the first passage having a higher temperature in the lower part and the second passage having a lower temperature in the upper part, it is expected that the vaporization of a flow rate of liquid refrigerant uniformly distributed on the heat exchanger tubes is higher in the tubes of the first passage at a higher temperature than that of the second passage: as a result of a uniform distribution on all the tubes, the liquid film distributed on the upper part will be in excess and will not vaporize completely, falling into the underlying portion and partially compensating for the lack of liquid refrigerant distributed on the lower portion of the tubes which will instead vaporize completely.

The compensation phenomenon will not be total since the exces-sive distribution of liquid in the upper part, where there is also the maximum flow rate of vapor, will also involve a non-negligible interaction between liquid and vapor, with consequent breakage of the liquid film and entrainment of the liquid in the vapor flow to the compressor suction connection.

As a consequence of the above, it would be optimal to distribute a greater quantity of refrigerant in the lower part of the tube bundle, in correspondence with the first passage of the fluid inside the tubes, than that distributed in the upper part, which becomes possible in the way described above.

This advantage is obtained in the application of a refrigeration cycle, when the flow of refrigerant fluid coming from the throttling/lamination device, typically an expansion valve, is divided between the several distribution layers.

To refine this distribution even further, each distribution layer may comprise a device for regulating the flow of refrigerant to the distribution layers, e.g. a valve.

Preferably the degree of opening of the devices for regulating the flow of refrigerant to the distribution layers is regulated by a control system. Typical parameters to be used as setting point to be controlled are, for example but not exclu-sively,
Superheating at compressor inlet,
Superheating at compressor outlet,
Compressor power input,
Compressor capacity regulation, or
Distribution layer pressure drop.

In another advantageous embodiment of the invention, the vertical distance between adjacent rows between rows of heat exchanger tubes forming the bundle of heat exchanger tubes is progressively increasing from bottom to top. This configuration allows to limit the velocity of the rising vapour which would tend to increase as it rises in height as a consequence of the increase in the total vapour flow. The velocity of the ascending vapor creates interaction with the liquid film on the external surface of the tubes, which interaction leads to the disruption of the liquid falling film, with negative consequences on the heat transfer coefficient.

The optimal increase of the distance between the tubes between different pairs of rows (from bottom to top), can follow a linear law for each subset of rows of tubes fed into them by the same passage of the heat transfer fluid (for all these tubes the process fluid has the same inlet temperature).

In another preferable embodiment, the cross-section of the shell in the yz plane is rectangular or square-shaped. In this way it is more easily possible to operate in pure falling film mode (not hybrid) still keeping the overall heat transfer performance high, minimizing the overall refrigerant charge, because the number of heat exchanger tubes per row can be equal, and this also in the bottom part of the shell, where instead with standard circular-shape shell cross-section, there is a big difference of number of tubes between adjacent rows.

It is precisely this large difference in the number of tubes per row of tubes, present in the standard configuration with circular-shape shell cross-section, which generates difficul-ties in obtaining an optimal distribution and which conse-quently requires an overfeeding of refrigerant in order not to collapse in performance, overfeeding which must then be man-aged with a recirculation system if one does not want to adopt the hybrid configuration. This solution is best suited for low pressure refrigerant like R1233zd and R1234ze, because this shape is less resistant to pressure.

Furthermore, it can be advantageous if an active mist eliminator or integrated heat exchanger is positioned above the uppermost refrigerant distribution layer in order to obtain the complete vaporization of the refrigerant before entering the compressor in a more reliable way even under extreme operating conditions. The hot medium flowing inside the tubes of this active mist eliminator or integrated heat exchanger may be liquid refrigerant from the condenser or from additional sub-coolers, or hot vapor from the hot gas line before entering the condenser. The refrigerant flow rate flowing inside the tubes can be the total one of the condenser or only a portion of it through a manual or automatic by-pass valve controlled by an input parameter like the ones discussed above. With this, remaining liquid portions in the ascending vapour stream can be evaporated and eliminated before leaving the evaporator.

For the sake of completeness, it is worth mentioning:
heat exchange tubes can be plain, finned/ribbed or any tube type developed to improve the heat transfer performance in a specific application by means of enhanced surface structures or porous coatings
distribution system can be positioned on/by the support plates/tube sheets, and
single pass, two pass or multi pass systems work with the described distribution systems. Returning to the clarifying example provided above, it becomes evident from this example that practical situations exist in which it is, e.g., optimal to distribute a greater quantity of refrigerant in the lower part of the tube bundle, in correspondence with the first passage of the fluid inside the tubes, than that distributed in the upper part. This task is solved by another aspect of the inventions provided herein.

A heat exchanger according to this aspect of the invention comprises a shell, at least one bundle of heat exchanger tubes that is arranged within the shell, said heat exchanger tubes having a tube length defining a horizontal x-direction and said bundle of heat exchanger tubes having a vertical extension defining a z-direction that is orthogonal to said x-direction, and at least one refrigerant distribution layer located above at least one bundle of heat exchanger tubes, said at least one refrigerant distribution layer comprising perforated pipes which have holes for emitting refrigerant towards the bundle of heat exchanger tubes above which said refrigerant distribution layer is located.

According to this aspect of the invention, the heat exchanger furthermore comprises several refrigerant distribution layers, is connected to at least one throttling/lamination device, e.g. an expansion valve, through which the refrigerant flows, and the refrigerant flow after the at least one throt-tling/lamination device is divided between at least two of the refrigerant distribution layers, wherein at least one of the two refrigerant distribution layers between which the refrigerant flow is divided comprise a device for regulating the flow of refrigerant to the distribution layers.

In this way, a significant control on the distribution of refrigerant over the respective bundles of heat exchanger tubes is achieved. Preferably, all refrigerant distribution layers comprise a device for regulating the flow of refrigerant. Also preferably, there is a control system controlling the degree of opening of the devices for regulating the flow of refrigerant to the distribution layers.

It is evident that the specific features and advantageous embodiments of this aspect of the invention can readily be com-bined with the specific features and advantageous embodiments of the first aspect of the invention, so that advantageous embodiments of the first aspect of the invention can be transferred directly to this aspect of the invention, leading to the same benefits.

Next, the invention is explained in more detail using figures that illustrate possible embodiments of the invention. The figures show:

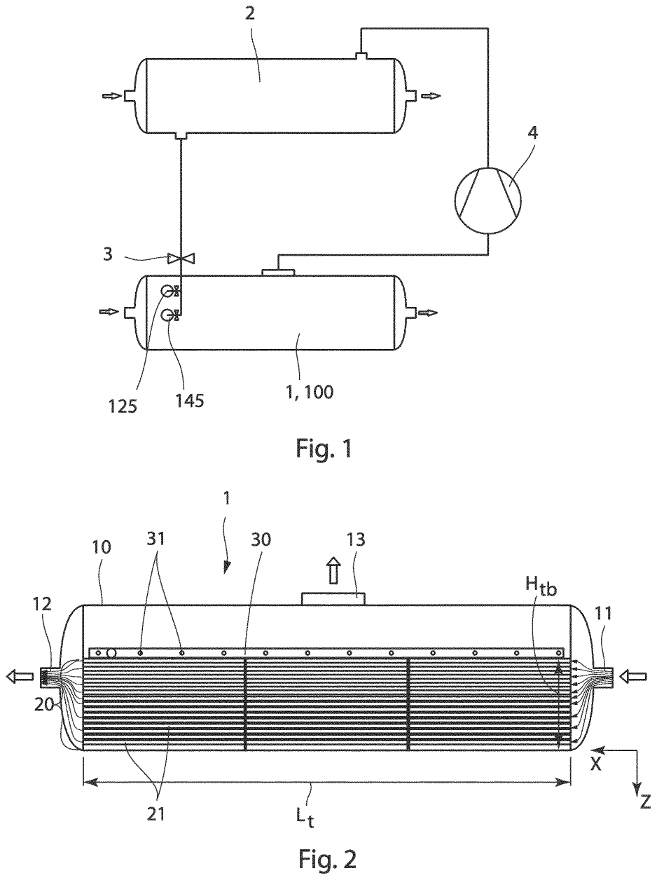

FIG. 1: A typical configuration for use of a heat exchanger,

FIG. 2: a view into a first embodiment of a heat exchanger,

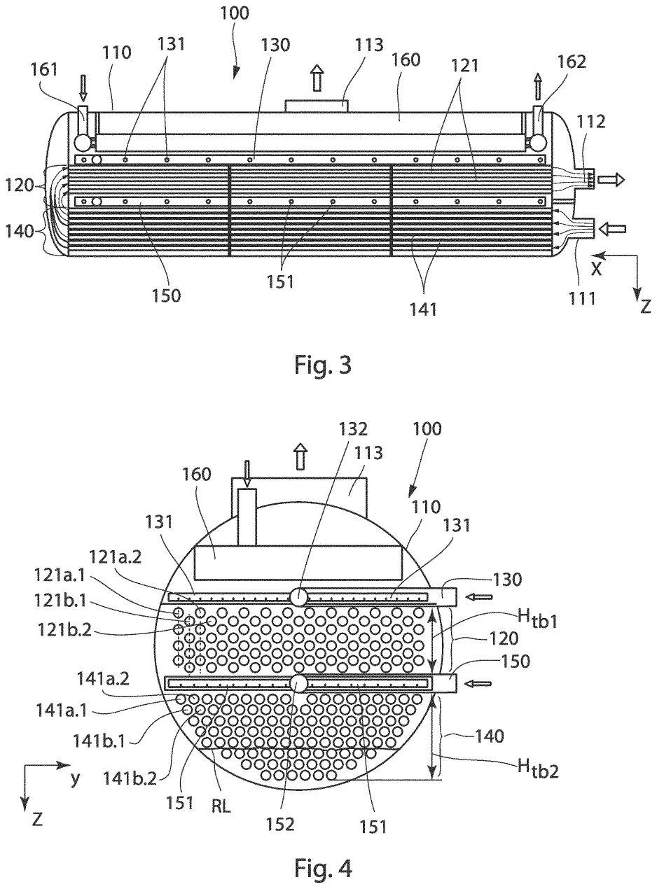

FIG. 3: a view into a second embodiment of a heat exchanger,

FIG. 4: a cross section through the embodiment of the heat exchanger shown in FIG. 3,

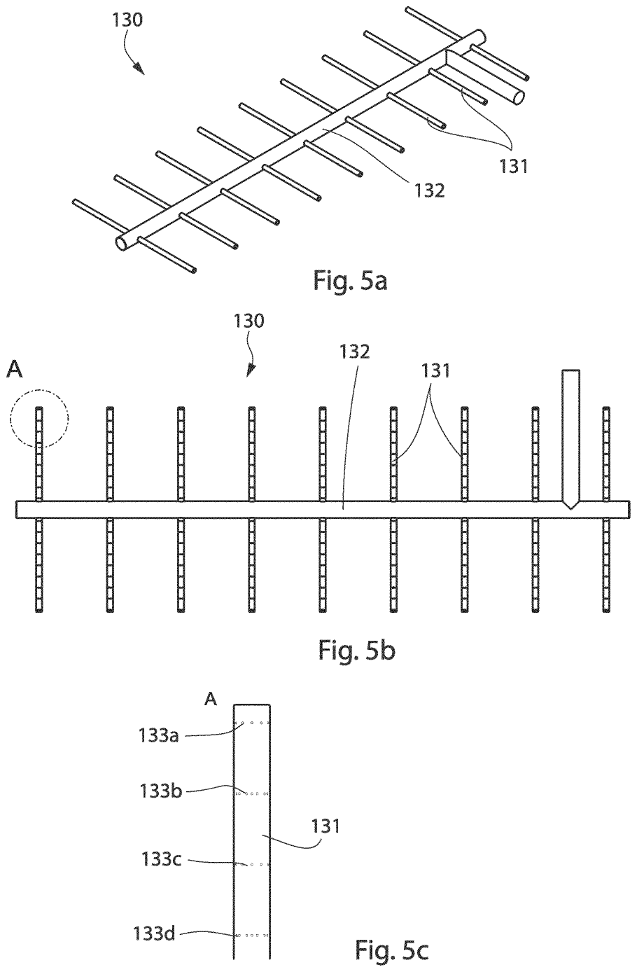

FIG. 5a: a first view of a refrigerant distribution layer,

FIG. 5b: a second view of the refrigerant distribution layer of FIG. 5a,

FIG. 5c: an enlarged detail of FIG. 5b,

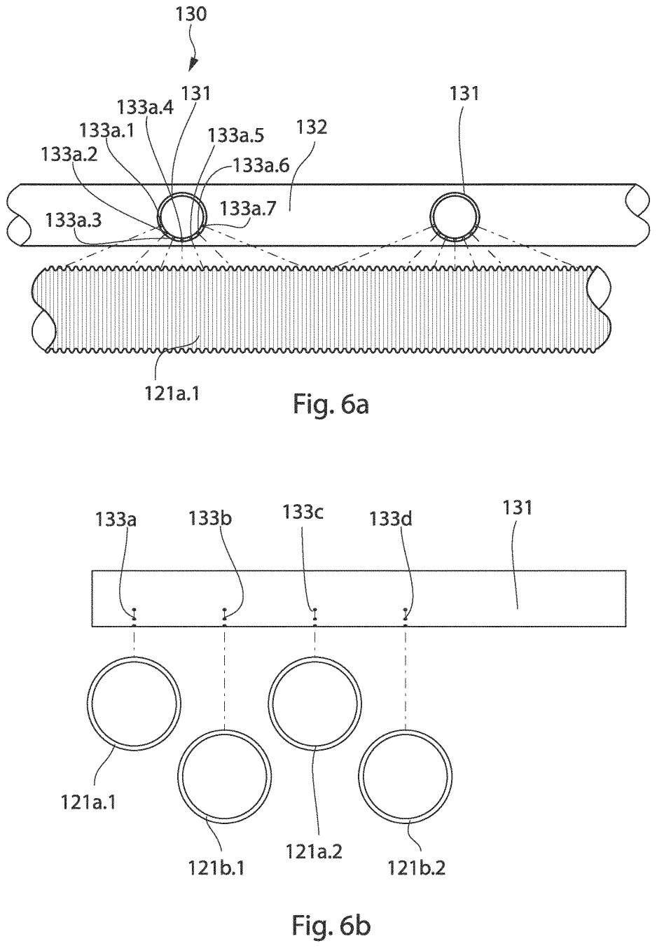

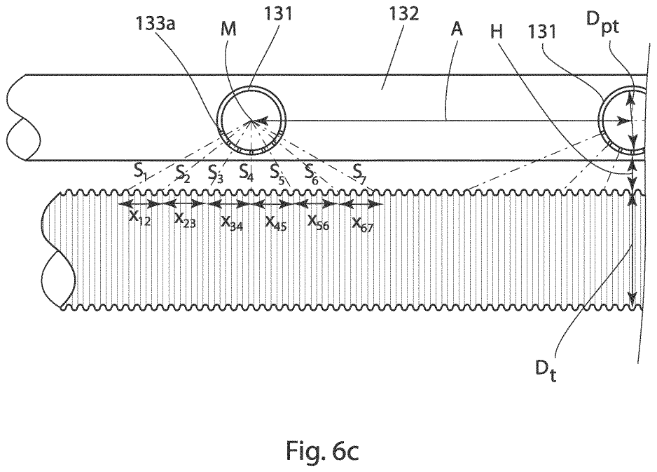

FIG. 6a: an first enlarged view showing aspects of the distribution of refrigerant onto the heat exchanger tubes,

FIG. 6b: a second enlarged view showing aspects of the distribution of refrigerant onto the heat exchanger tubes,

FIG. 6c: a third enlarged view showing geometrical details of the distribution of refrigerant onto the heat exchanger tubes,

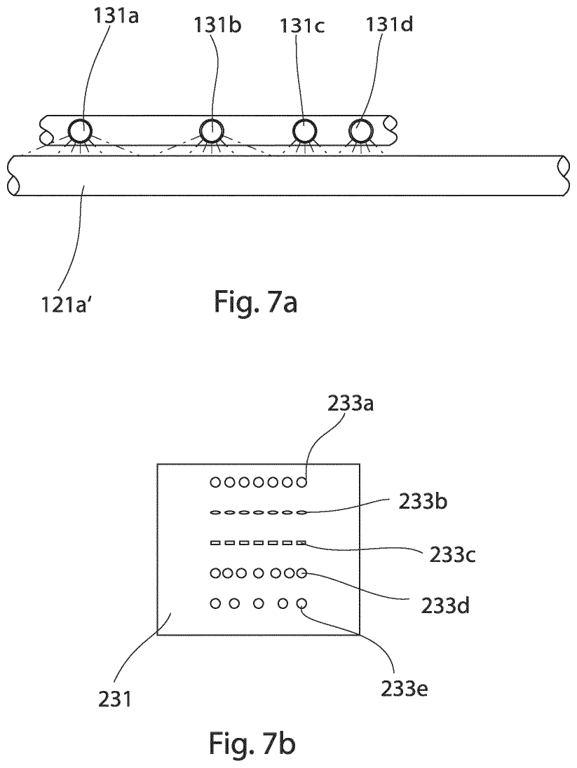

FIG. 7a: a variant of FIG. 6a, illustrating further aspects of the distribution of refrigerant onto the heat exchanger tubes,

FIG. 7b: various possible configurations of sets of holes,

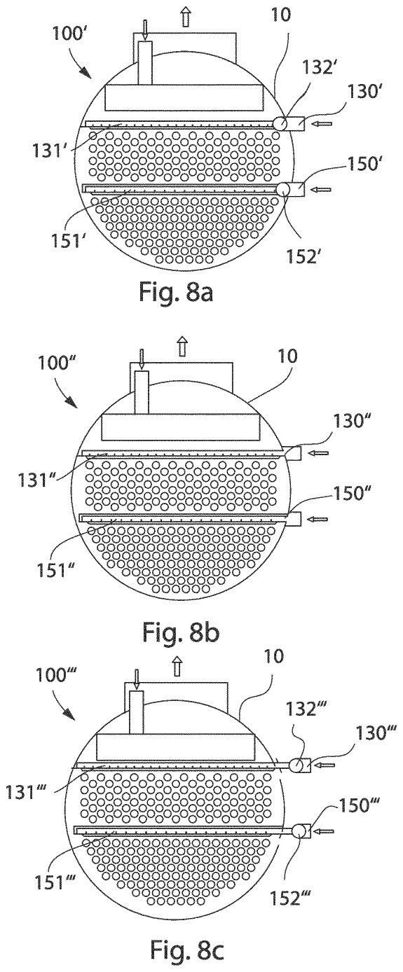

FIG. 8a-c: three variants of the heat exchanger shown in FIG. 4,

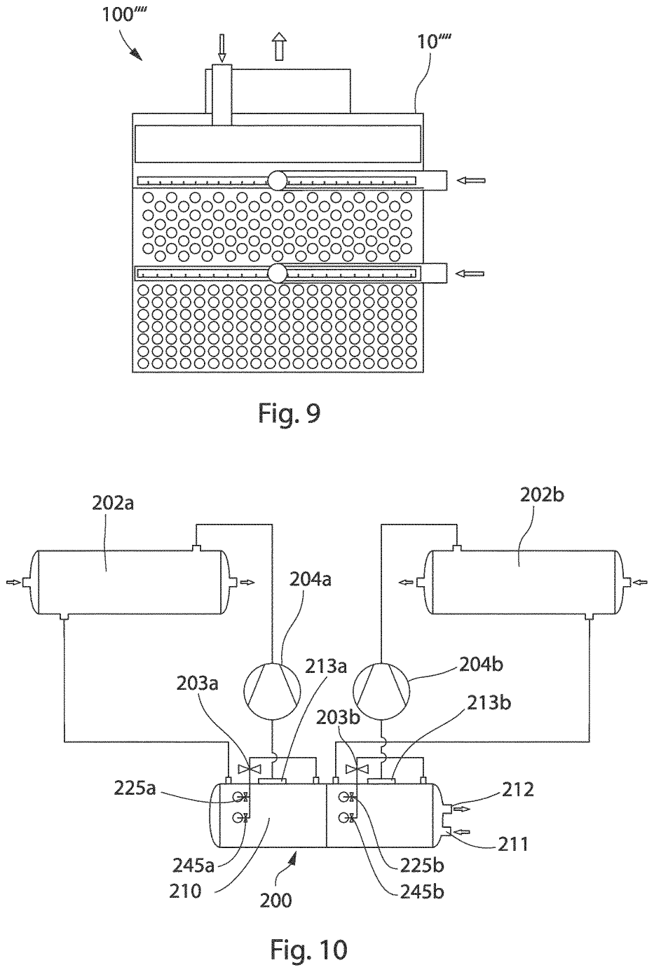

FIG. 9: a further variant of the heat exchanger shown in FIG. 4,

FIG. 10: an alternative configuration for use of a heat exchanger, and

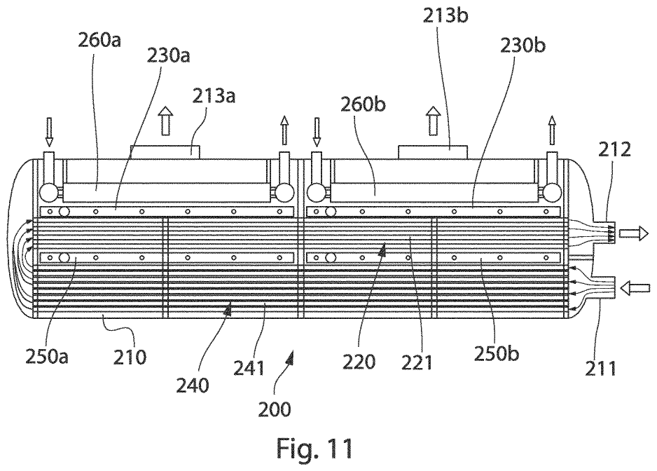

FIG. 11: a view into a third embodiment of a heat exchanger.

In the figures, identical reference numerals are used for identical parts, unless stated otherwise. However, in order to improve the clarity of the figures, not all reference numerals are shown in all figures and at all locations where they could be applied.

FIG. 1 shows a typical configuration for use of a heat exchanger 1,100, wherein two reference numerals are used to illustrate that both the heat exchanger 1 of FIG. 2 and the heat exchanger 100 of FIG. 3 could be used in this configuration. In the displayed configuration, hot fluid enters the heat exchanger 1,100 on its left side, is cooled inside the heat exchanger 1,100 by interaction with the refrigerant and leaves the heat exchanger 1,100 on the right side. In the embodiment of FIG. 1, the refrigerant is provided from a heat removing heat exchanger 2 and passes through a throttling/lamination device, here represented as an expansion valve 3 prior to being fed into the heat exchanger's refrigerant distribution layers.

It should be noted that in the embodiment of FIG. 1 the refrigerant flow after the expansion valve 3 is divided between the two refrigerant distribution layers 130,150, wherein each distribution layer comprises a device 125,145, which can be realized, e.g., as a valve, for regulating the flow of refrigerant to the respective distribution layer. The degree of opening of the devices 125,145 for regulating the flow of refrigerant to the distribution layers is regulated by a control system that is not shown in FIG. 1. The control system can use as setting point to be controlled one or several parameters, such as, e.g., Superheating at compressor inlet, Superheating at compressor outlet, Compressor power input, Compressor capacity regulation or Distributor pressure drop, . . . .

The refrigerant is then distributed by the refrigerant distribution layer 30,130,150 of the heat exchanger 1,100 and brought into contact with the heat exchanger tubes 21,121,141 in which the fluid to be cooled is flowing as described below in more detail, and evaporates in the cooling process. The resulting refrigerant vapour is sucked in by a compressor 4, compressed and fed back into the heat removing heat exchanger 2.

In contrast to FIG. 1, which shows mainly the shell of the heat exchanger 1,100, the views into its respective inside that are shown in FIGS. 2, 3 and 4, respectively, allow to identify the heat exchangers 1,100 as heat exchangers of horizontal tube falling film evaporator type. Inside a shell 10,110 with a fluid inlet 11,111, a fluid outlet 12,112 and a refrigerant outlet 13,113, at least one bundle 20,120,140 of heat exchanger tubes 21,121,141 is arranged, into which the fluid to be cooled is distributed, as indicated by the arrows at the fluid inlet 11,111 in FIGS. 2 and 3, respectively.

The heat exchanger tubes 21,121,141 have a tube length Lₜ (displayed only in FIG. 2) defining a horizontal x-direction. The bundles 20,120,140 are essentially groups of heat exchanger tubes 21,121,141; the space that a given group 20,120,140 requires in the vertical direction defines its vertical extension H_{tb},H_{tb1},H_{tb2} and defines a vertical z-direction that is orthogonal to said x-direction. As can be recognized from the Figures, the tube length Lₜ exceeds the vertical extension H_{tb},H_{tb1},H_{tb2}. This implies that the refrigerant is distributed predominantly in the form of a falling film and not also as a liquid predominantly entrained and distributed by an ascending vapor.

Furthermore, as can be seen in FIGS. 2 and 3, respectively the respective heat exchangers 1,100 of horizontal tube falling film evaporator type, each comprise at least one refrigerant distribution layer 30,130,150 located above at least one bundle 20,120,140 of heat exchanger tubes 21,121,141. The distribution layers 30,130,150 comprise perforated pipes 31,131,151 for emitting refrigerant towards the bundle 20,120,140 of heat exchanger tubes 21,121,141 above which said refrigerant distribution layer 30,130,150 is located. Therefore, the refrigerant leaves the refrigerant distribution layer at numerous locations through the perforations of the perforated pipes 31,131,151 and is dripping or jetting onto the heat exchanger tubes 21,121,141 located below. If parts of the refrigerant are not evaporated during the interaction with the heat exchanger tubes 21,121,141, there may be liquid refrigerant present in the bottom part of the shell 10,110, as exemplified in FIG. 4, where a refrigerant level RL is indicated.

It should be noted that the perforated pipes 31,131,151 have a longitudinal y-direction that is orthogonal to the longitudinal x-direction defined by the heat exchanger tubes 21,121,141 and the vertical z-direction defined by the respective extension H_{tb},H_{tb1}, H_{tb2}, which means that they are running orthogonal to the paper plane in the representations of FIGS. 2 and 3.

Further details of the refrigerant distribution layers 30,130,150 and the way they distribute the refrigerant onto the heat exchanger tubes 21,121,141 are shown in FIGS. 5a to 5c and 6a to 6c, respectively, using the refrigerant distribution layer 130 as a representative example. As can be seen in these figures, the shown embodiments of refrigerant distribution layers 30,130,150 are comprised of a central refrigerant feed pipe 32,132,152 that extends parallel to the heat exchanger tubes 21,121,141 and several perforated pipes 31,131,151 having a longitudinal axis defining a horizontal y-direction that is orthogonal to the x-direction defined by said heat exchanger tubes 21,121,141. The perforated pipes 31,131,151 that extend opposite to each other from opposite sides of the central refrigerant feed pipe 32,132,152. More specifically, in this example said perforated pipes 31,131,151 are connected directly to the respective central feed pipe 32,132,152, forming an antenna-like structure.

It is important to stress, however, that refrigerant distribution layers with the features attributed to them in claim 1 are not limited to the structure shown in FIGS. 2 to Sc. To illustrate this, three variants of refrigerant distribution layers 130′,150′; 130″,150″ and 130′″,150′″, respectively are shown in FIG. 8a to 8c for variants 100′, 100″ and 100′″ of the heat exchanger 100 as shown in FIG. 4. As all other components are identical to the embodiment of FIG. 4 (some additional aspects of which are discussed below), reference numerals are omitted with the sole exception of the reference numeral of the shell 10, which is identical in all of the variants of FIGS. 4 and 8.

A first difference between the variants shown in FIG. 4 and FIG. 8, respectively is that in FIG. 8 each of the perforated pipes 131′,151′,131″,151″,131′″,151′″, extends over the whole bundle (in y direction) and is supplied with refrigerant from one side.

The difference between the variants shown in FIG. 8 is the way how the perforated pipes 131′,151′,131″,151″,131′″, 151′″ are supplied with refrigerant. In refrigerant supply systems 130′ and 150′, this is obtained by a common supply line 132′,152′ that is located inside the shell 10 and fed from outside the shell 10. In refrigerant supply system 130″, this is obtained by leading the individual perforated pipes 131″,151″ through the shell 10 and feeding them individually with refrigerant. In refrigerant supply system 130′″, this is obtained by leading the individual perforated pipes 131′″, 151′″ through the shell 10 and feeding them with refrigerant using a common supply line 132′″,152′″.

As best seen in FIGS. 5c and 6a, the perforations of the perforated pipes 31,131,151 are formed by holes 133a.1,133a.2, 133a.3,133a.4,133a.5,133a.6,133a.7 that are arranged in sets 133a,133b,133c,133d. Each set 133a,133b,133c,133d of holes is arranged on a circumference lying on a vertical xz-plane that passes through a heat exchanger tube 21,121,141,121a.1 of the bundle 20,120,140 and located above a respective heat exchanger tube 121a.1,121a.2,121b.1,121b.2,141a.1,141a.2,141b.1, 141b.2 of said bundle 20,120,140 of heat exchanger tubes 21,121,141. Ideally, the plane passes through the centerline of the heat exchanger tube, such that the emitted refrigerant flows down on the whole surface of the heat exchanger tube to allow for optimal heat transfer.

The effect of the feature that the holes 133a.1,133a.2,133a.3, 133a.4,133a.5,133a.6,133a.7 that belong to the set 133a are arranged on a circumference lying on a vertical xz-plane that passes through a heat exchanger tube 21,121,141,121a.1 of the bundle 20,120,140 are immediately visible in FIGS. 6a and 6c: the refrigerant emerges in several jets from the perforated pipe 131 and is thus immediately distributed along the longitudinal x-direction of the heat exchanger tube 121a.1, allowing for a more homogenous distribution of refrigerant and an improved cooling effect. In fact, when choosing the distance A between adjacent perforated pipes 131 adequately, an essentially equal distribution of refrigerant on the heat exchanger tube 121a can be achieved in the portion of the heat exchanger 121a directly fed by each perforated pipe 131.

As several sets 133a,133b,133c,133d of holes are provided along the perforated pipe 131, and located above a respective heat exchanger tube 121a.1,121a.2,121b.1,121b.2,141a.1,141a.2, 141b.1,141b.2 of said bundle 20,120,140 of heat exchanger tubes 21,121,141, as best seen in FIGS. 6b and 4, this effect can be achieved for each of the heat exchanger tubes in the top two rows of a given bundle 20,120,140 of heat exchanger tubes 21,121,141. Therefore, a much more optimized distribution of refrigerant an much better cooling effect can be achieved compared to the use of distributor plates that is known from the prior art, especially if one uses the numerous degrees of freedom, especially with respect to the number and the grouping of the holes belonging to a set, their shape and diameter as well as the distance between adjacent perforated pipes for a consequent optimization of the refrigerant distribution.

Some of these degrees of freedom are visualized in FIGS. 7a and 7b, respectively. In FIG. 7a, the distance between respective adjacent pairs of perforated pipes 131a,131b/131b, 131c/131c,131d is varied. In addition, the sets of holes of perforated pipes 131a,131b comprise 7 holes, whereas the sets of holes of perforated pipes 131c, 131d comprise 5 holes, leading to a variation of the length of the section of the heat exchanger tube 121a′ that receives refrigerant from a respective perforated pipe 131a,131b,131c,131d.

Another variation is shown in FIG. 7b, which illustrates different possibilities for the configuration of holes in sets 233a,233b,233c,233d and 233e of holes of a perforated pipe 231 that is illustrated in a representation where the cylin-drical wall of perforated pipe 231 is rolled off and thus forms a square. Set 233a is comprised of seven circular holes that are spaced equidistantly. Set 233b is comprised of seven slit-like holes that are spaced equidistantly. Set 233c is comprised of seven rectangular holes that are spaced equidistantly. Set 233d is comprised of seven circular holes with varying space between the holes. Set 233e is comprised of five circular holes with varying space between the holes. Thus, shape and number of holes as well as distances between the holes can be varied. Naturally, it is also possible to vary the size of the holes and to combine holes of different shape within a set of holes. With this modification of the perforated pipes and their arrangement to each other, specific heat transfer requirements and goals can be fullfilled. For example more refrigerant can be distributed onto sections with higher A T (inlet of fluid to be cooled) or where a higher number of heat exchanger tubes are arranged below the specific set of holes (near the shell less tubes, less refrigerant can be evaporated than in the center of the heat exchanger)

An aspect of some embodiments of the invention can be seen in FIGS. 4,8 and 9: The vertical distance between adjacent rows between rows of heat exchanger tubes 121a.1,121a.2,121b.1, 121b.2, . . . and 141a.1,141a.2,141b.1, 141b2, respectively, forming the respective bundle 120,140 of heat exchanger tubes 121,141 is varied; especially it can be progressively increasing from bottom to top. This configuration allows to limit the velocity of the rising vapor which would tend to increase as one rises in height as a consequence of the increase in the total vapor flow.

Yet another variant 100″″ of the heat exchanger 100 is shown in FIG. 9. As in the case of FIG. 8, only the reference numerals that relate to the part which is varied have been added to this Figure; as the remainder of the features shown in FIG. 9 is identical to the ones in FIG. 4, it is not mentioned separately. The difference between heat exchanger 100 and 100″″ is the shape of the shell 10″″, which is rectangular and, to be more precise, essentially square-shaped. In this way it is more easily possible to operate in pure falling film mode (not hybrid), minimizing the overall refrigerant charge, because the number of heat exchanger tubes per row can be equal. This solution is best suited for low pressure refrigerant like R1233zd and R1234ze, because this shape is less resistant to pressure.

Last not least, as seen in FIGS. 3 and 4 the heat exchanger 100 also includes active mist eliminator 160, an integrated regenerative heat exchanger, positioned above the uppermost refrigerant distribution layer 130,131,132 in order to obtain the complete vaporization of the refrigerant entering the compressor in a more reliable way even under extreme operating conditions. The hot medium flowing inside the tubes of this active mist eliminator 160 or integrated heat exchanger may be liquid refrigerant from the condenser or from additional sub-coolers, or hot vapor from the hot gas line before entering the condenser. The refrigerant flow rate flowing inside the tubes can be the total one of the condenser or only a portion of it through a manual or automatic by-pass valve controlled by an input parameter like the ones discussed above. The hot medium enters this integrated regenerative heat exchanger through the inlet connection 161, is distributed inside the heat exchanger tubes and exits cooled through the outlet connection 162. In the heat exchange process, the hot medium has transferred heat to the rising refrigerant vapour flow produced by the heat exchanger tubes, which vapour flows into contact with the external surface, with or without fins, of the tubes of the integrated regenerative heat exchanger. With this, remaining liquid portions in the ascending vapour stream can be evaporated and eliminated before leaving the evaporator.

FIG. 10 shows an alternative configuration for use of a heat exchanger 200. In this configuration, heat exchanger 200 is operating with two refrigerant circuits. Accordingly, the refrigerant is provided from two different heat removing heat exchangers 202a,202b.

Heat exchanger 200 is a third embodiment of a heat exchanger, which is configured in this example as shown in FIG. 11. Inside a shell 210 with a fluid inlet 211, a fluid outlet 212 and two refrigerant outlets 213a,213b, two bundles 220,240 of heat exchanger tubes 221,241 are arranged, into which the fluid to be cooled is distributed, as indicated by the arrows at the fluid inlet 211 in FIG. 10. The heat exchanger 200 comprises two pairs of layers 230a,250a and 230b,250b, respectively, which are arranged above respective sections of the bundels 220,240. Each of the refrigeration layers 230a,230b, 250a and 250b may be realized in a similar way as described above.

As is evident from FIG. 11, refrigerant distribution layers 230a,230b and 250a,250b, respectively, are arranged horizontally next to each other and are arranged above different sections of the same bundle 220,240 of heat exchanger tubes 221,241.

Conversely, refrigerant distribution layers 230a,250a and 230b,250b, respectively, are arranged vertically above each other and distant to each other in the vertical z-direction in such a way relative to the bundles 220,240 of heat exchanger tubes 221,241 that each refrigerant distribution layer 230a,230b,250a,250b is arranged above at least one bundle of heat exchanger tubes 221,241.

As can be seen in FIG. 10, after the refrigerant has passed through a respective throttling/lamination device, here represented as an expansion valves 203a,203b prior it is fed into the respective refrigerant distribution layers 230a,250a,230b, 250b via individual devices 225a,225b,245a,245b for regulating the flow of refrigerant to the distribution layers 230a,250a, 230b,250b, so that the flow of refrigerant can be controlled individually, preferably by means of a control system (not shown).

Returning to FIG. 10, in the configuration displayed therein hot fluid enters the heat exchanger 200 at the lower portion of its right side, is cooled inside the heat exchanger 200 by interaction with the refrigerant and leaves the heat exchanger 200 at the upper portion of the right side. In the embodiment of FIG. 10, the refrigerant is provided from two different heat removing heat exchangers 202a,202b and passes through a throttling/lamination device, here represented as an expansion valve 203a,203b prior to being fed into the heat exchanger's refrigerant distribution layers.

It should be noted, however, that in this embodiment prior to the expansion of the refrigerant, it is passing in its liquid state (and thus hot compared to the temperature of evaporated refrigerant) through active mist eliminators 260a,260b, which act as a heating unit to evaporate remaining liquid content of refrigerant in the exiting vapour located inside the shell 210.

The resulting refrigerant vapour is thus purified and subse-quently sucked in by a respective compressor 204a,204b, compressed and fed back into respective the heat removing heat exchanger 202a,202b.

Reference numerals

| | |
|---|---|
| 1, 100, 100′, 100′′, 100′′′, 100′′′′ | heat exchanger |
| 2, 202a, 202b | heat removing heat exchanger |
| 3, 203a, 203b | expansion valve |
| 4, 204a, 204b | compressor |
| 10, 10′′′′, 110, 210 | shell |
| 11, 111, 211 | fluid inlet |
| 12, 112, 212 | fluid outlet |
| 13, 113, 213a, 213b | refrigerant outlet |
| 20, 120, 140, 220, 240 | bundle |
| 21, 121, 141, 221, 241 | heat exchanger tubes |
| 121a.1, 121a.2, 121b.1, 121b.2 | heat exchanger tubes |
| 141a.1, 141a.2, 141b.1, 141b.2 | heat exchanger tubes |
| 30, 130, 130′, 130′′, 130′′′ | refrigerant distribution |
| | layer |
| 150, 150′, 150′′, 150′′′ | refrigerant distribution |
| | layer |
| 31, 131, 131′, 131′′, 131′′′ | perforated pipe |
| 151, 151′, 151′′, 151′′′, 232 | perforated pipe |
| 32, 132, 152 | feed pipe |
| 132′, 132′′′, 152, 152′, 152′′′ | supply line |
| 133a, 133b, 133c, 133d | set of holes |
| 133a.1, 133a.2, 133a.3, 133a.4, | hole |
| 133a.5, 133a.6, 133a.7 | |
| 125, 145, 225a, 225b, 245a, 245b | device for regulating flow |
| 160, 260a, 260b | active mist eliminator |
| 161 | inlet connection |
| 162 | outlet connection |
| 230a, 230b, 250a, 250b | refrigerant distribution |
| | layer |
| 233a, 233b, 233c, 233d, 233e | set of holes |
| H_{tb}, H_{tb1}, H_{tb2}, | extension |
| Lₜ | tube length |
| A | distance |
| M | center |
| RL | refrigerant level |

1. Heat exchanger (1,100,200) of horizontal tube falling film evaporator type, said heat exchanger (1,100,200) comprising
a shell (10,110,210),
at least one bundle (20,120,140,220,240) of heat exchanger tubes (21,121,141,221,241) that is arranged within the shell (10,110,210), said heat exchanger tubes (21,121, 141,221,241) having a tube length (Lₜ) defining a horizontal x-direction and said bundle (20,120,140,220,240) of heat exchanger tubes (21,121,141,221,241) having a vertical extension (H_{tb}, H_{tb1}, H_{tb2}) defining a z-direction that is orthogonal to said x-direction, and
at least one refrigerant distribution layer (30,130,150,230a,230b,250a,250b) located above at least one bundle (20,120,140,220,240) of heat exchanger tubes (21,121,141,221,241), said at least one refrigerant distribution layer (30,130,150,230a, 230b,250a,250b) comprising perforated pipes (31,131,151) which have holes (133a.1,133a.2,133a.3,133a.4,133a.5, 133a.6,133a.7) for emitting refrigerant towards the bundle (20,120,140,220,240) of heat exchanger tubes (21,121,141,221,241) above which said refrigerant distribution layer (30,130,150,230a,230b, 250a,250b) is located, characterized in that at least some of said perforated pipes (31,131,151) have a longitudinal axis defining a horizontal y-direction that is orthogonal to the x-direction defined by said heat exchanger tubes (21,121,141,221,241) and that perforations of the perforated pipes (31,131,151) are formed by holes (133a.1,133a.2,133a.3,133a.4,133a.5,133a.6,133a.7) that are arranged in sets (133a,133b,133c,133d), wherein each set (133a,133b,133c,133d) of holes is arranged on a circumference, which circumference is lying on a vertical xz-plane that passes through a heat exchanger tube (21,121,141,221,241) of the bundle (20,120,140,220,240) and wherein the holes of a given set (133a,133b,133c,133d) of holes are located above a respective heat exchanger tube (121a.1,121a.2,121b.1,121b.2, 141a.1,141a.2,141b.1, 141b.2) of said bundle (20,120,140,220,240) of heat exchanger tubes (21,121,141,221,241), so that refrigerant emitted from the holes of a given set (133a,133b,133c, 133d) of holes propagates towards this heat exchanger tube (121a.1,121a.2,121b.1,121b.2,141a.1,141a.2,141b.1,141b.2).

2. Heat exchanger (1,100,200) according to claim 1, characterized in that the number (nₕ) of holes (133a.1,133a.2, 133a.3,133a.4,133a.5,133a.6,133a.7) per set is between 5 and 11.

3. Heat exchanger (1,100,200) according to claim 1, characterized in that the number (nₕ) of holes (133a.1,133a.2, 133a.3,133a.4,133a.5,133a.6,133a.7) per set is odd and that the position of the holes (133a.1, 133a.2,133a.3,133a.4,133a.5,133a.6,133a.7) of a set is symmetric relative to a central hole (133a.4) that is positioned at the bottom of the perforated pipe (131) that faces directly the heat exchanger tube (121) located below said set of holes (133a.1,133a.2,133a.3,133a.4,133a.5, 133a.6,133a.7).

4. Heat exchanger (1,100,200) according to claim 1,
characterized in that the holes (133a.1, 133a.2,133a.3,133a.4,133a.5,133a.6,133a.7) of a given set (133a) of holes are arranged in such a way that the respective distances (x₁₂,x₂₃,x₃₄,x₄₅,x₅₆,x₆₇) between a first intersection point that is formed by a respective first straight line (s₁,s₂,s₃,s₄,s₅,s₆) passing through a first hole (133a.1,133a.2,133a.3,133a.4,133a.5,133a.6) and the center (M) of the perforated pipe (131) with the heat exchanger tube (121a.1) located below said set of holes (133) and a second intersection point that is formed by a respective second line (s₂,s₃,s₄,s₅,s₆,s₇) passing through a neighboring second hole (133a.2,133a.3,133a.4,133a.5, 133a.6,133a.7) and the center (M) of the perforated pipe (131) with the heat exchanger tube (121a.1) located below said set of holes (133) are equal.

5. Heat exchanger (1,100,200) according to claim 1,
characterized in that the condition
1<(A/Dₚₚ)/nₕ<3 is met, wherein A defines the distance between the centers (M) of two adjacent perforated pipes (131) having a longitudinal axis defining a horizontal y-direction that is orthogonal to the x-direction defined by said heat exchanger tubes (21,121,141,221,241), Dₚₚ is the diameter of the perforated pipes (131) and nₕ is the number of holes (133a.1,133a.2,133a.3, 133a.4,133a.5, 133a.6,133a.7) belonging to a set of holes (133a).

6. Heat exchanger (1,100,200) according to claim 1,
characterized in that the at least one refrigerant distribution layer (30,130,150,230a,230b,250a,250b) is comprised of a central refrigerant feed pipe (32,132,152) that extends parallel to the heat exchanger tubes (21,121,141) and several perforated pipes (31,131,151) having a longitudinal axis defining a horizontal y-direction that is orthogonal to the x-direction defined by said heat exchanger tubes (21,121, 141), wherein perforations of the perforated pipes (31,131,151) are formed by holes (133a.1,133a.2,133a.3, 133a.4,133a.5,133a.6,133a.7) that are arranged in sets (133a,133b,133c,133d), wherein each set (133a,133b,133c, 133d) of holes is arranged on a circumference lying on a vertical xz-plane that passes through a heat exchanger tube (21,121,141,221,241) of the bundle (20,120,140,220,240) and located above a respective heat exchanger tube (121a.1,121a.2, 121b.1,121b.2,141a.1, 141a.2,141b.1,141b.2) of said bundle (20,120,140,220,240) of heat exchanger tubes (21,121,141,221,241), wherein said perforated pipes (31,131,151) are connected directly to the central feed pipe (32,132,152).

7. Heat exchanger (1,100,200) according to claim 1,
characterized in that the heat exchanger (1,100,200) comprises several refrigerant distribution layers (30,130,150,230a,230b,250a, 250b).

8. Heat exchanger (1,100,200) according to claim 7,
characterized in that the heat exchanger (1,100,200) comprises several refrigerant distribution layers (30,130,150,230a,230b,250a,250b) that are arranged horizontally next to each other.

9. Heat exchanger (1,100,200) according to claim 8,
characterized in that at least two refrigerant distribution layers (30,130,150,230a,230b,250a,250b) that are arranged horizontally next to each other are arranged above different sections of the same bundle (20,120,140,220,240) of heat exchanger tubes (21,121,141, 221,241).

10. Heat exchanger (1,100,200) according to claim 7,
characterized in that the heat exchanger (1,100,200) comprises several refrigerant distribution layers (30,130,150,230a,230b,250a,250b) that are arranged vertically above each other and distant to each other in the vertical z-direction and also comprises several bundles (20,120,140,220, 240) of heat exchanger tubes (21,121,141, 221,241) that are arranged vertically above each other and distant to each other in the vertical z-direction, said several refrigerant distribution layers (30,130,150,230a,230b,250a,250b) and said several bundles (20,120,140,220,240) of heat exchanger tubes (21,121,141,221,241) being arranged in such a way that each refrigerant distribution layer (30,130,150,230a,230b,250a,250b) is arranged above at least one bundle (20,120,140,220,240) of heat exchanger tubes (21,121,141,221,241).

11. Heat exchanger (1,100,200) according to claim 7, characterized in that the heat exchanger (1,100,200) is connected to a throttling/lamination device (3,203a,203b) through which the refrigerant flows and that the refrigerant flow after the throttling/lamination device (3,203a,203b) is divided between the refrigerant distribution layers (30,130,150,230a,230b,250a,250b).

12. Heat exchanger (1,100,200) according to claim 11,
characterized in that each distribution layer (30,130,150,230a,230b,250a,250b) comprises a device (125,145,225a,225b,245a,245b) for regulating the flow of refrigerant to the distribution layers (30,130,150,230a, 230b,250a,250b).

13. Heat exchanger (1,100,200) according to claim 12,
characterized in that the degree of opening of the devices (125,145,225a,225b,245a,245b) for regulating the flow of refrigerant to the distribution layers (30,130,150,230a,230b,250a,250b) is regulated by a control system.

14. Heat exchanger (1,100,200) according to claim 10, characterized in that the vertical distance between adjacent rows between rows of heat exchanger tubes (121a.1,121a.2,121b.1,121b.2; 141a.1,141a.2,141b.1, 141b.2) forming the bundle (120,140,220,240) of heat exchanger tubes (121,141,221,241) is varied and advantageously it is progressively increasing from bottom to top.

15. Heat exchanger (1,100,200) according to claim 1, characterized in that the cross-section of the shell (10,110,210) in the yz plane is rectangular or square-shaped.

16. Heat exchanger (1,100,200) according to claim 1, characterized in that a heating unit to evaporate remaining liquid content of refrigerant in the exiting vapour (160,260a,260b) is positioned above the uppermost refrigerant distribution layer (130,230a,230b).

17. Heat exchanger (1,100,200) according to claim 1, characterized in that at least some of the holes (133a.1,133a.2,133a.3,133a.4,133a.5,133a.6,133a.7) have different shapes and/or sizes.

18. Heat exchanger (1,100,200) according to claim 1. characterized in that at least some of the sets (133a,133b,133c,133d) of holes comprise different numbers of holes (133a.1,133a.2,133a.3,133a.4,133a.5, 133a.6,133a.7).

19. Heat exchanger (1,100,200) according to the preamble of claim 1,
characterized in that the heat exchanger (1,100,200) comprises several refrigerant distribution layers (30,130,150,230a,230b,250a,250b),
in that the heat exchanger (1,100,200) is connected to at least one throttling/lamination device (3,203a,203b) through which the refrigerant flows,
in that the refrigerant flow after the at least one throttling/lamination device (3,203a,203b) is divided between at least two of the refrigerant distribution layers (30,130,150,230a,230b,250a,250b), and
in that at least one of the several refrigerant distribution layers (30,130,150,230a,230b,250a,250b) between which the refrigerant flow is divided comprise a device (125,145,225a, 225b,245a,245b) for regulating the flow of refrigerant to the distribution layers (30,130,150,230a, 230b,250a,250b).
